(19) United States
(12) Patent Application Publication
(10) Pub. No.: US 2018/0309580 A1
(43) Pub. Date: Oct. 25, 2018

(54) ELECTRONIC DEVICE FOR AUTHENTICATION SYSTEM

(71) Applicant: SAMSUNG ELECTRONICS CO., LTD., Suwon-si (KR)

(72) Inventors: Sang-Hoon JEON, Hwaseong-si (KR); Hyungsup KIM, Hwaseong-si (KR); Wonjae LEE, Hwaseong-si (KR)

(73) Assignee: SAMSUNG ELECTRONICS CO., LTD., Suwon-si (KR)

(21) Appl. No.: 15/848,262

(22) Filed: Dec. 20, 2017

(30) Foreign Application Priority Data
Apr. 24, 2017 (KR) 10-2017-0052509

(51) Int. Cl. H04L 9/32; H04L 9/06; H04L 9/14

(52) U.S. Cl. CPC H04L 9/3242; H04L 9/14; H04L 9/0643

(57) ABSTRACT

An electronic device includes: a processor configured to obtain a first authentication key based on first data and a first authentication message, verify the first authentication message based on the first authentication key, obtain a second authentication key based on second data and a second authentication message, and verify the second authentication message based on the second authentication key; and a memory configured to store the first data, the first authentication message, the first authentication key, the second data, the second authentication message, and the second authentication key, wherein the second authentication message and the second authentication key are different from the first authentication message and the first authentication key, respectively, and the first authentication key and the second authentication key are associated with a first end device and a second end device, respectively.

### CROSS-REFERENCE TO THE RELATED APPLICATION

This application claims priority from Korean Patent Application No. 10-2017-0052509 filed Apr. 24, 2017, in the Korean Intellectual Property Office, the disclosure of which is incorporated herein in its entirety by reference.

### BACKGROUND

Apparatuses and methods consistent with exemplary embodiments of the inventive concept disclosed herein relate to an electronic device, and more particularly, to an authentication system.

With the development of information technologies, personal information may be stored and processed by an electronic device or etc. Accordingly, an authentication system has developed to protect personal information of users from a malicious attack. The authentication system may be based on an encoding technology. The encoding technology is a technology for preventing people except for users having specific knowledge from obtaining specific information. Accordingly, the encoding technology includes a technology for converting a data value indicating specific information by using a complicated algorithm.

The encoding technology includes a symmetric key-based encoding technology and an asymmetric key-based encoding technology. In the symmetric key-based encoding technology, the same key is used in processes of encoding data and decoding the encoded data. Accordingly, the symmetric key used in the symmetric key-based encoding technology is a secret key that should not be exposed to a third party. In contrast, two different types of keys (a public key and a private key) are used in the asymmetric key-based encoding technology. It does not matter that the public key is exposed to a third party. The public key is used to encode a message. The private key should not be exposed to a third party. The private key is used to decode an encoded message.

The encoding technology is becoming more important as an Internet of Things (IoT) system is applied to an everyday life. The IoT system may perform information exchange and processing of exchanged information without intervention of a person. Low-power end devices are included in the IoT system. Accordingly, an authentication system used in the IoT system uses a symmetric key-based encoding technology that does not require high computation capacity. However, if a symmetric key is exposed, the security of the symmetric key-based encoding technology is seriously threatened.

### SUMMARY

Exemplary embodiments of the inventive concept provide an authentication system for authenticating an end device.

According to an aspect of an exemplary embodiment, there is provided an electronic device, such as a hub, which may include a processor and a memory. The processor may be configured to obtain a first authentication key based on first data and a first authentication message, verify the first authentication message based on the first authentication key, obtain a second authentication key based on second data and a second authentication message, and verify the second authentication message based on the second authentication key. The memory may be configured to store the first data, the first authentication message, the first authentication key, the second data, the second authentication message, and the second authentication key. Here, the second authentication message may be different from the first authentication message, the second authentication key may be different from the first authentication key, the first authentication key may be associated with a first end device, and the second authentication key may be associated with a second end device.

According to an aspect of an exemplary embodiment, there is provided an electronic device, which as an end device may include: a secure module configured to create a first authentication message based on a first authentication key; and a memory configured to store data associated with the first authentication message. Here, the first authentication key may be associated with the secure module, the first authentication key may be different from a second authentication key associated with another secure module, and the first authentication message may be different from a second authentication message associated with the second authentication key.

According to an aspect of exemplary embodiment, there is provided an electronic device, such as a hub, which may include a processor and a memory. The processor may be configured to: receive a first authentication message created from a first authentication key associated with a first end device, receive a second authentication message created from a second authentication key associated with a second end device, obtain a third authentication key from the first authentication message, obtain a fourth authentication key from the second authentication message, verify the first authentication message based on the third authentication key, and verify the second authentication message based on the fourth authentication key. The memory may be configured to store data associated with the first authentication message, the second authentication message, the third authentication key, and the fourth authentication key. Here, the third authentication key may be a symmetric key with respect to the first authentication key, and the fourth authentication key may be a symmetric key with respect to the second authentication key.

### BRIEF DESCRIPTION OF THE DRAWINGS

The above and other objects and features will become apparent from the following description with reference to the accompanying drawings, wherein like reference numerals refer to like parts throughout the various figures unless otherwise specified, in which:

FIG. 1 is a diagram illustrating an example of authentication system according to an exemplary embodiment of the inventive concept;

FIG. 2 is a block diagram illustrating an example of authentication system according to an exemplary embodiment of the inventive concept;

FIG. 3 is a block diagram illustrating an example of protocol to generate an authentication key;

FIG. 4 is a block diagram illustrating an example of protocol to generate an authentication message in an end device of FIG. 1;

FIG. 5 is a block diagrams illustrating an example of method obtaining data from an authentication message;

FIG. 6 is a block diagram illustrating an example of protocol to verify an authentication message in a hub of FIG. 1;

FIG. 7 is a flowchart illustrating an example of method for verifying an authentication message by an authentication system, according to an exemplary embodiment of the inventive concept;

FIG. 8 is a block diagram illustrating an example of electronic device for implementing an end device and a hub of FIG. 1, according to an exemplary embodiment of the inventive concept; and

FIG. 9 is a conceptual diagram illustrating an example of Internet of Things system for implementing an authentication system, according to an exemplary embodiment of the inventive concept.

### DETAILED DESCRIPTION

Below, exemplary embodiments of the inventive concept are described in detail and clearly to such an extent that an ordinary one in the art easily may be able to implement the inventive concept.

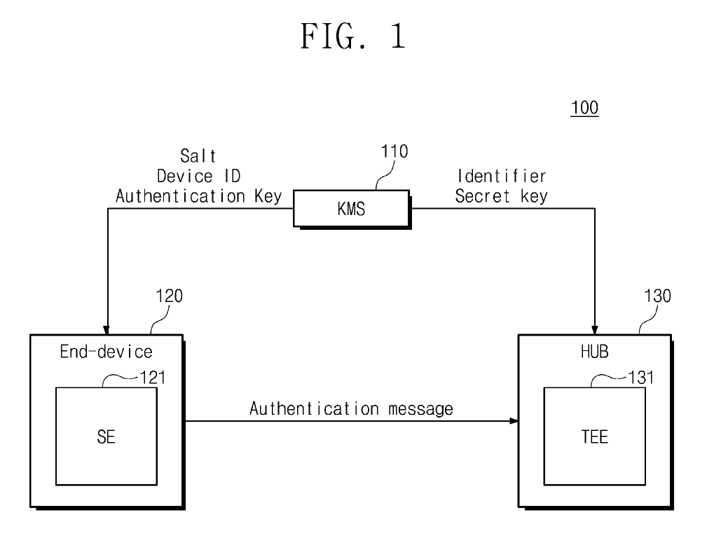

FIG. 1 is a diagram illustrating an example of authentication system according to an exemplary embodiment of the inventive concept. Referring to FIG. 1, an authentication system 100 may include a key management system (KMS) 110, an end device 120, and a hub 130. The end device 120 may provide a security function based on a secure element (SE) 121. The hub 130 may provide a security function based on a trusted execution environment (TEE) 131.

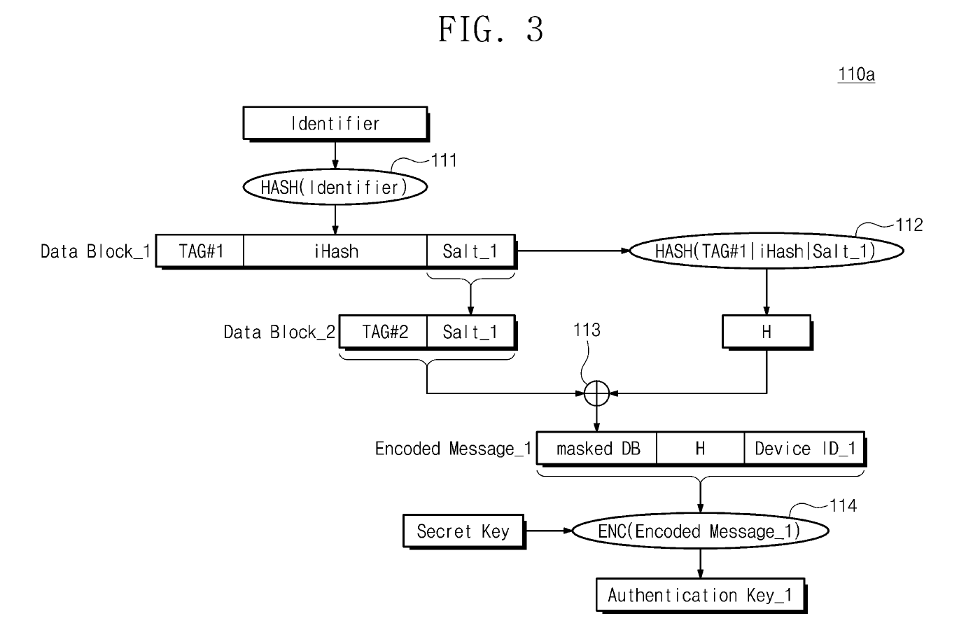

The key management system 110 may create a salt, a device identifier (ID), an identifier, and a secret key. The key management system 110 may create an authentication key based on the salt, the device ID, the identifier, and the secret key. A detailed protocol for creating the authentication key will be described with reference to FIG. 3.

For example, the key management system 110 may randomly create data, bits of which are specified in number, and may use the created data as the identifier. Alternatively, the key management system 110 may create data for indicating information (e.g., information associated with a product group to which the end device 120 belongs) associated with the end device 120, and may use the created data as the identifier.

For example, the key management system 110 may randomly create data, bits of which are specified in number, and may use the created data as the salt. The salt may be used when a hash value is calculated from specific data by using a hash function. Hash values different from one another may be calculated from the same data and the same hash function by different salts.

For example, the key management system 110 may create data associated with information (e.g., a manufacturer's name of the end device 120) associated with the end device 120, and may use the created data as the device ID. Alternatively, the key management system 110 may create data associated with information (e.g., a model name of a secure module) associated with a security module included in the end device 120, and may use the created data as the device ID.

For example, the secret key may be a symmetric key that is able to be used to perform a symmetric key-based encoding operation. The secret key may be used for an encoding operation for converting specific data based on a promised protocol.

At a point in time when the end device 120 is manufactured (i.e., before the end device 120 is used by users), the key management system 110 may send the salt, the device ID, and the authentication key to the end device 120. The salt, device ID, and authentication key received from the key management system 110 may be stored in the end device 120. The authentication key may be stored in the end device 120 by a security function that is provided on the basis of the SE 121. In addition, at a point in time when the hub 130 is manufactured (i.e., before the hub 130 is used by users), the key management system 110 may send the identifier and the secret key to the hub 130. The identifier and secret key received from the key management system 110 may be stored in the hub 130 by a security function that is provided on the basis of the TEE 131.

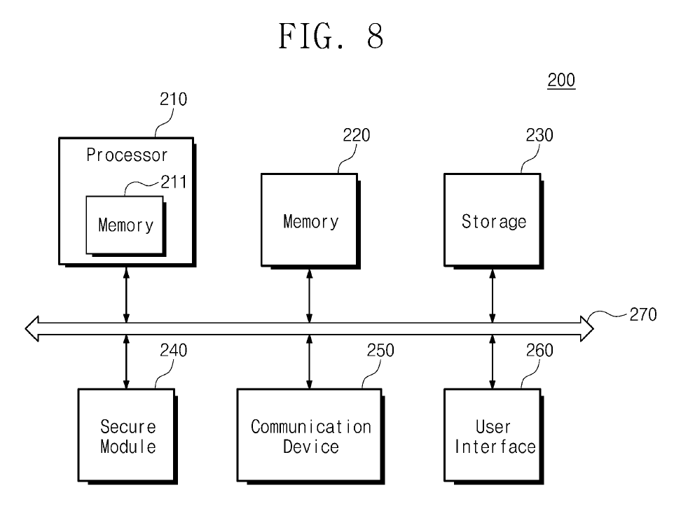

For example, the key management system 110 may include a set of computing devices for creating and managing data to be used in the authentication system 100. Accordingly, the key management system 110 may include one or more processors, one or more memories, one or more storages, and the like. An exemplary implementation of the key management system 110 will be described with reference to FIG. 8.

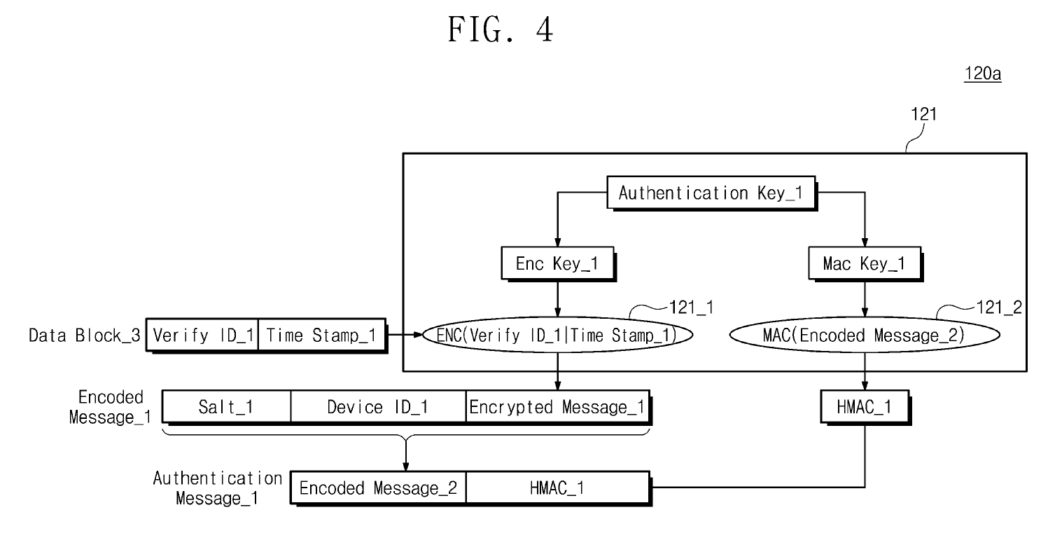

The end device 120 may receive the salt, the device ID, and the authentication key from the key management system 110. The end device 120 may create an authentication message based on the received salt, device ID, and authentication key. A detailed protocol for creating the authentication message will be described with reference to FIG. 4.

The end device 120 may send the created authentication message to the hub 130. For example, the end device 120 may send the created authentication message to the hub 130 through a security channel. Alternatively, the end device 120 may send the created authentication message to the hub 130 through a normal channel.

For example, the end device 120 may include a secure module that provides a security function based on the SE 121. For example, the secure module may include storage. A security function that is provided based on the SE 121 may allow only a verified user to access the secure module. The secure module that operates in a secure mode based on the SE 121 will be described with reference to FIG. 8.

The hub 130 may receive the identifier and the secret key from the key management system 110. The hub 130 may obtain an authentication key based on the identifier and the secret key. A detailed protocol for obtaining the authentication key will be described with reference to FIG. 3.

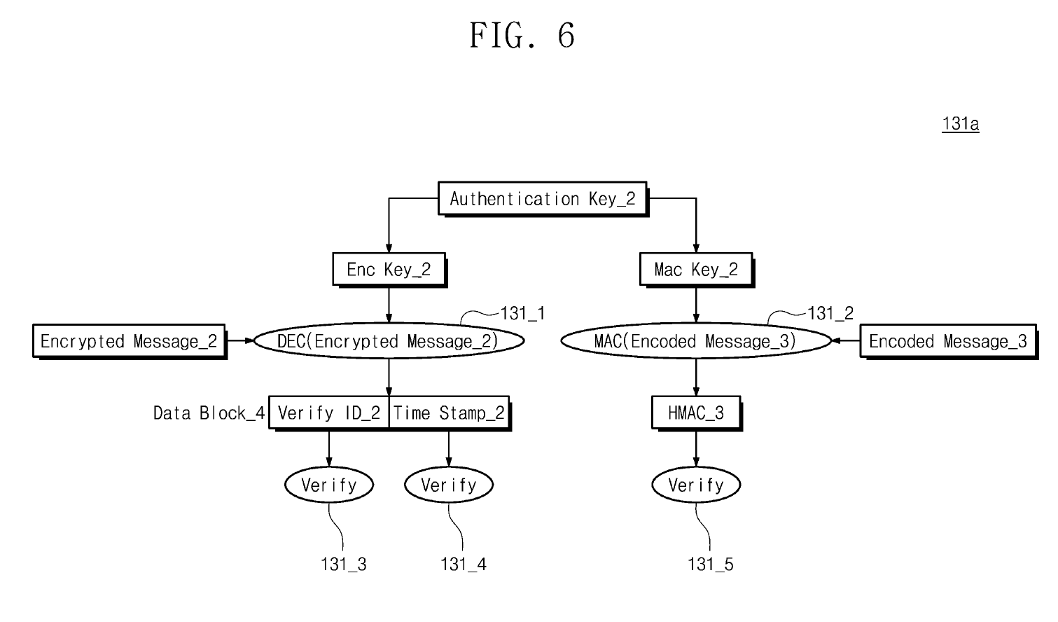

The hub 130 may receive an authentication message from the end device 120. The hub 130 may obtain data necessary for authentication from the received authentication message. The hub 130 may verify the received authentication message based on the obtained data and authentication key. A detailed protocol for authenticating the received authentication message will be described with reference to FIG. 6.

For example, the hub 130 may include a processor that provides a security function based on the TEE 131. For example, the processor may include a memory. The security function that is provided based on the TEE 131 may allow only a verified user to access the processor. The processor that operates in a secure mode based on the TEE 131 will be described with reference to FIG. 8.

When an authentication message created in the end device 120 is verified by the hub 130, the end device 120 may acquire an authority to exchange data with the hub 130. For example, in a case where the end device 120 and the hub 130 are included in the IoT system, the end device 120 and the hub 130 need to exchange data associated with a user that makes use of the IoT system. In a case where data associated with the user requires a high level of security, the hub 130 may make a request to the end device 120 for authentication. For example, the hub 130 may send an authentication request message for requesting authentication to the end device 120. The end device 120 may create an authentication message in response to the request of the hub 130. After the created authentication message is verified by the hub 130, the hub 130 may exchange data related to the user with the end device 120.

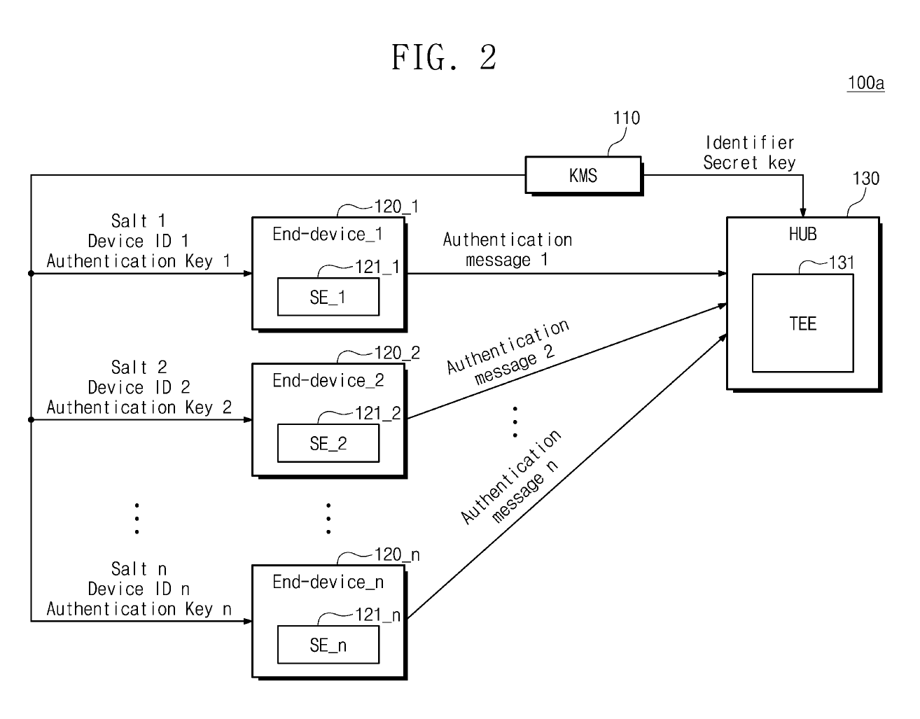

FIG. 2 is a block diagram illustrating an example of authentication system according to an exemplary embodiment of the inventive concept. Referring to FIG. 2, an authentication system 100a may include a key management system 110, a hub 130, and first to n-th end devices 120_1 to 120_n. The first to n-th end devices 120_1 to 120_n may provide security functions based on first to n-th SEs 121_1 to 121_n, respectively.

The key management system 110 may create first to n-th salts, first to n-th device IDs, an identifier, and a secret key. The key management system 110 may create first to n-th authentication keys based on the first to n-th salts, the first to n-th device IDs, the identifier, and the secret key. A protocol for creating the first to n-th authentication keys may be similar to a protocol for creating the authentication key of FIG. 1.

The first to n-th salts may be the same as one another. Alternatively, at least one of the first to n-th salts may be different from the remaining salts. The first to n-th device IDs may be the same as one another. Alternatively, at least one of the first to n-th device IDs may be different from the remaining device IDs.

For example, in a case where the first salt and the second salt are the same as each other, the first and second device IDs may be different from each other. Alternatively, in a case where the first and second salts are different from each other, the first and second device IDs may be the same as each other. Alternatively, the first and second salts may be different from each other, and the first and second device IDs may be different from each other. Accordingly, the first authentication key that is created based on the first salt and the first device ID may be different from the second authentication key that is created based on the second salt and the second device ID. As in the above description, the first to n-th authentication keys may be different from each other.

The key management system 110 may send the first to n-th salts, the first to n-th device IDs, and the first to n-th authentication keys to the first to n-th end devices 120_1 to 120_n, respectively. When the first to n-th end devices 120_1 to 120_n are manufactured, the first to n-th salts, the first to n-th device IDs, and the first to n-th authentication keys may be respectively sent to the first to n-th end devices 120_1 to 120_n. The first to n-th salts, first to n-th device IDs, and first to n-th authentication keys received from the key management system 110 may be respectively stored in the first to n-th end devices 120_1 to 120_n. These first to n-th authentication keys may be respectively stored in the first to n-th end devices 120_1 to 120_n that provide security functions based on the first to n-th SEs 121_1 to 121_n.

The first to n-th end devices 120_1 to 120_n may receive the first to n-th salts, the first to n-th device IDs, and the first to n-th authentication keys from the key management system 110, respectively. The first to n-th end devices 120_1 to 120_n may respectively create the first to n-th authentication messages based on the received first to n-th salts, first to n-th device IDs, and first to n-th authentication keys. A protocol for creating the first to n-th authentication messages may be similar to a protocol for creating the authentication message of FIG. 1. Since the authentication messages are created based on different authentication keys, the authentication messages may be different from each other.

The first to n-th end devices 120_1 to 120_n may send the first to n-th authentication messages to the hub 130. For example, the first to n-th end devices 120_1 to 120_n may send the first to n-th authentication messages to the hub 130 through secure channels. Alternatively, the first to n-th end devices 120_1 to 120_n may provide the first to n-th authentication messages to the hub 130 through normal channels.

FIG. 3 is a block diagram illustrating an example of protocol 110a to generate an authentication key. The key management system 110 may generate an authentication key depending on the protocol 110a. The hub 130 may obtain the authentication key according to the protocol 110a.

For example, a hash function 111, a hash function 112, an XOR operation 113, and an encoding operation 114 of FIG. 3 to be described below may be performed by one or more computing devices. Alternatively, the operations of FIG. 3 may be performed by the hub 130. More specifically, the operations of FIG. 3 may be performed by a processor that operates in a secure mode based on the TEE 131 shown in FIG. 2.

In an example of FIG. 3, the hash function 111 and the hash function 112 may include an operation for converting data of the first number of bits into data of the second number of bits. For example, a hash function may be any one of functions such as SHA-128, SHA-256, and SHA-512.

In an example of FIG. 3, the XOR operation 113 may be a logical operation. For example, the following table 1 shows results obtained when the XOR operation 113 is performed by using 1-bit data.

TABLE 1

A

| | | 0 | 1 |
|---|---|---|---|
| B | 0 | 0 | 1 |
| | 1 | 1 | 0 |

In an example of the table 1, “A” and “B” may be input values. Referring to the table 1, in a case where “A” and “B” have the same value, a value of the XOR operation 113 may be “0”. In a case where “A” and “B” have different values, a value of the XOR operation 113 may be “1”.

The XOR operation 113 may be used as an encoding operation and a decoding operation. For example, in a case where the XOR operation 113 is performed on “1010” (data to be encoded) and “1111” (a key used for encoding and decoding), a value of the XOR operation 113 may be “0101” (encoded data). In a case where the XOR operation 113 is performed on “0101” (encoded data) and “1111” (a key used for encoding and decoding), a value of the XOR operation 113 may be “1010” (decoded data). Accordingly, the XOR operation 113 may be used as an operation for data masking. Below, an exemplification in which the XOR operation 113 is used as an operation for data masking will be described with reference to FIG. 3.

The XOR operation 113 may be used as an operation for data authentication. In a case where two input values are the same, a value of the XOR operation 113 may be a specific value (e.g., “0”) regardless of input values. For example, in a case where the XOR operation 113 is performed on “1110” (data to be verified) and “1111” (a reference value), a value of the XOR operation 113 may be “0001”. Since a least significant bit of the XOR operation value is “1”, it may be understood that a least significant bit of the value to be verified and a least significant bit of the reference value do not coincide with each other. In a case where the value to be verified and the reference value do not coincide with each other, authentication may be denied. An exemplification in which the XOR operation 113 is used as an operation for data authentication will be described with reference to FIG. 6.

In an example of FIG. 3, the encoding operation 114 may include an operation of converting specific data by using a symmetric key (e.g., a secret key of FIG. 3). The data converted by the encoding operation 114 may be decoded by using the same symmetric key as the symmetric key used in the encoding operation 114.

As described with reference to FIG. 1, the key management system 110 may create an identifier, a salt “Salt_1”, and a device ID “Device ID_1”. The hub 130 may receive the identifier, the salt “Salt_1”, and the device ID “Device ID_1” from the key management system 110.

Also, the key management system 110 may create a first tag “TAG#1” and a second tag “TAG#2”. Each of the first tag “TAG#1” and the second tag “TAG#2” may be any data having the given number of bits. The first tag “TAG#1” and the second tag “TAG#2” may be used to indicate a location of a data block. For example, the first tag “TAG#1” and the second tag “TAG#2” may be used in a process of parsing the protocol 110a.

The hub 130 may create a third tag “TAG#3” and a fourth tag “TAG#4”. Characteristics of the third tag “TAG#3” and the fourth tag “TAG#4” are similar to the first tag “TAG#1” and the second tag “TAG#2”, and a description thereof is thus omitted. Below, the protocol 110a using the first tag “TAG#1” and the second tag “TAG#2” will be described with reference to FIG. 3. Below, the protocol 110a will be described step by step.

Referring to FIG. 3, the key management system 110 may calculate a hash value “iHASH” from the identifier by using the hash function 111.

The key management system 110 may create a first data block “Data Block_1” including the first tag “TAG#1”, the hash value “iHASH”, and the salt “Salt_1”. The key management system 110 may calculate a hash value “H” from the first data block “Data Block_1” by using the hash function 112.

The key management system 110 may create a second data block “Data Block_2” including the second tag “TAG#2” and the salt “Salt_2”. The key management system 110 may calculate a masked database “masked DB” from the second data block “Data Block_2” and the hash value “H” by using the XOR operation 113. The XOR operation 113 may be used as an operation for data masking. Accordingly, the masked database “masked DB” may be data (or masked data) that are masked by the XOR operation 113.

The key management system 110 may create an encoded message “Encoded Message_1” including the masked database “masked DB”, the hash value “H”, and the device ID “Device ID_1”. The key management system 110 may perform the encoding operation 114 by using the secret key. The key management system 110 may create an authentication key from the encoded message by using the encoding operation 114. The created authentication key may be sent to the end device 120.

Configurations of the first data block “Data Block_1”, the second data block “Data Block_2”, and the encoded message “Encoded Message_1” illustrated in FIG. 3 are examples, and exemplary embodiments of the inventive concept are not limited thereto. The first data block “Data Block_1” may include the first tag “TAG#1”, the hash value “iHASH”, and the salt “Salt_1” that are arranged in an order different from an order illustrated in FIG. 3. For example, the first data block “Data Block_1” may include a data block “TAG#1|Salt_1| iHash” that is configured in an order of the first tag “TAG#1”, the salt “Salt_1”, and the hash value “iHASH”. The second data block “Data Block_2” and the encoded message “Encoded Message_1” are configured in a manner that is similar to the first data block “Data Block_1”, and a description thereof is thus omitted.

As described with reference to FIG. 2, the authentication system according to an exemplary embodiment of the inventive concept may include a plurality of end devices. A salt to be sent to at least one of the plurality of end devices may be different from salts to be sent to the remaining end devices. Alternatively, a device ID to be sent to at least one of the plurality of end devices may be different from device IDs to be sent to the remaining end devices. Alternatively, a device ID and a salt to be sent to at least one of the plurality of end devices may be different from device IDs and salts to be sent to the remaining end devices.

Accordingly, at least one of authentication keys that are created based on salts and device IDs may be different from the remaining authentication keys. One authentication key to be sent to at least one of the plurality of end devices by the key management system 110 may be different from authentication keys to be sent to the remaining end devices.

An authentication key different from the other authentication keys may be leaked out by an attacker. Since the authentication key leaked out is different from the other authentication keys, the attacker may fail to obtain the other authentication keys from the authentication key leaked out. Accordingly, the authentication system that makes use of one authentication key different from the other authentication keys may have a higher level of security than an authentication system using the same authentication key.

FIG. 4 is a block diagram illustrating an example of protocol 120a to generate an authentication message in an end device of FIG. 1.

An encoding operation 121_1 and a message authentication code operation 121_2 of FIG. 4 to be described below may be performed in a secure module included in the end device 120 of FIG. 1. The secure module may perform operations of FIG. 4 by using a security function based on the SE 121. Accordingly, a process of FIG. 4 may be safely protected from an external attack.

In an example of FIG. 4, the encoding operation 121_1 may include an operation for converting specific data by using a symmetric key (e.g., an encoding key “Enc Key_1” of FIG. 4). The data converted by the encoding operation 121_1 may be decoded by using the same symmetric key as the symmetric key used in the encoding operation 121_1.

In an example of FIG. 4, the message authentication code operation 121_2 may include an operation for converting specific data by using a message authentication key “Mac Key_1”. The message authentication code operation 121_2 may include an operation including a hash function.

The end device 120 may receive an authentication key “Authentication Key_1”, a salt “Salt_1”, and a device ID “Device ID_1” from the key management system 110. As described with reference to FIG. 1, the end device 120 may include the secure module. The received authentication key “Authentication Key_1” may be stored in the secure module that provides the security function based on the SE 121. The encoding operation 121_1 and the message authentication code operation 121_2 may be performed by the secure module that operates in the secure mode based on the SE 121.

The authentication key “Authentication Key_1” may include the encoding key “Enc Key_1” and the message authentication key “Mac Key_1”. For example, the encoding key “Enc Key_1” may include a least significant bit (LSB) of the authentication key “Authentication Key_1”, and the message authentication key “Mac Key_1” may include a most significant bit (MSB) of the authentication key “Authentication Key_1”. Alternatively, the encoding key “Enc Key_1” may include an MSB of the authentication key “Authentication Key_1”, and the message authentication key “Mac Key_1” may include an LSB of the authentication key “Authentication Key_1”. Below, the protocol 120a will be described step by step.

The end device 120 may obtain the encoding key “Enc Key_1” and the message authentication key “Mac Key_1” from the authentication key “Authentication Key_1” received from the key management system 110.

The end device 120 may create a verify ID “Verify ID_1” and a time stamp “Time Stamp_1”. For example, the verify ID “Verify ID_1” may include data that are randomly generated for verification. Before the authentication message “Authentication Message_1” is created according to the protocol 120a, the hub 130 and the end device 120 may share the verify ID “Verify ID_1”. For example, the time stamp “Time Stamp_1” may include data associated with a time (e.g., a time when the encrypted message “Encrypted Message_1” is created) for authentication. Authentication that is performed by using the verify ID “Verify ID_1” and the time stamp “Time Stamp_1” will be described with reference to FIG. 6.

The end device 120 may create a third data block “Data Block_3” that includes the verify ID “Verify ID_1” and the time stamp “Time Stamp_1”. The end device 120 may perform the encoding operation 121_1 by using the encoding key “Enc Key_1”. The end device 120 may create the encrypted message “Encrypted Message_1” from the third data block “Data Block_3” by the encoding operation 121_1.

Accordingly, the encrypted message “Encrypted Message_1” may include data converted from the verify ID “Verify ID_1” and the time stamp “Time Stamp_1”. Since the encoding operation 121_1 is performed by the security function based on the SE 121, an attacker may fail to obtain data associated with the verify ID “Verify ID_1” and the time stamp “Time Stamp_1” from the encrypted message “Encrypted Message_1”.

As described with reference to FIG. 3, the salt “Salt_1” and the device ID “Device ID_1” may be used when the hub 130 obtains the authentication key “Authentication Key_1”. Also, the encrypted message “Encrypted Message_1” may be used for authentication performed in the hub 130, which will be described with reference to FIG. 6. Accordingly, the end device 120 may create an encoded message “Encoded Message_2” to send the salt “Salt_1”, the device ID “Device ID_1” and the encrypted message “Encrypted Message_1” to the hub 130.

The end device 120 may perform a message authentication code operation by the secure module that operates in secure mode based on the SE 121. The end device 120 may perform the message authentication code operation 121_2 by using the message authentication key “Mac Key_1”. The end device 120 may create a hash message authentication code “HMAC_1” from the encoded message “Encoded Message_2” by the message authentication code operation 121_2.

Accordingly, the hash message authentication code “HMAC_1” may include data converted from the encoded message “Encoded Message_2”. Since the message authentication code operation 121_2 is performed by the security function based on the SE 121, an attacker may fail to obtain data associated with the encoded message “Encoded Message_2” from the encoded hash message authentication code “HMAC_1”. The hash message authentication code “HMAC_1” may be used to verify whether the encoded message “Encoded Message_2” is tampered with. Authentication using the hash message authentication code “HMAC_1” will be described with reference to FIG. 6.

The end device 120 may create the authentication message “Authentication Message_1” including the encoded message “Encoded Message_2” and the hash message authentication code “HMAC_1”. As described with reference to FIG. 1, the created authentication message “Authentication Message_1” may be sent to the hub 130 in response to a request of the hub 130.

Configurations of the third data block “Data Block_3”, the encoded message “Encoded Message_2”, and the authentication message “Authentication Message_1” illustrated in FIG. 4 are an example, and exemplary embodiments of the inventive concept are not limited thereto. The third data block “Data Block_3” may include the verify ID “Verify ID_1” and the time stamp “Time Stamp_1” that are arranged in an order different from an order illustrated in FIG. 4. For example, the third data block “Data Block_3” may include a data block “Time Stamp_1|Verify ID_1” that is configured in an order of the time stamp “Time Stamp_1” and the verify ID “Verify ID_1”. The encoded message “Encoded Message_2” and the authentication message “Authentication Message_1” are also configured in a manner that is similar to the third data block “Data Block_3”, and a description thereof is thus omitted.

The authentication message “Authentication Message_1” may be leaked out by an attacker. Since the authentication message “Authentication Message_1” includes data encrypted by the encoding operation 121_1 and the message authentication code operation 121_2, the attacker may fail to obtain the authentication key “Authentication Key_1” from the authentication message “Authentication Message_1”. Accordingly, the authentication system that transmits the authentication message “Authentication Message_1” may have a higher level of security than an authentication system directly transmitting the authentication key “Authentication Key_1”.

As described with reference to FIGS. 2 and 3, the authentication system according to an exemplary embodiment of the inventive concept may include a plurality of end devices. At least one of authentication keys that are created by the key management system 110 may be different from the remaining authentication keys. Accordingly, in a case where a plurality of authentication messages are created by the protocol 120a of FIG. 4, authentication messages created based on different authentication keys may be different from each other.

One authentication message different from the other authentication messages may be leaked out by an attacker. Since one authentication message leaked out is different from the other authentication messages, the attacker may fail to obtain the other authentication messages from one authentication message leaked out. Accordingly, the authentication system that makes use of one authentication message different from the other authentication messages may have a higher level of security than an authentication system using the same authentication message.

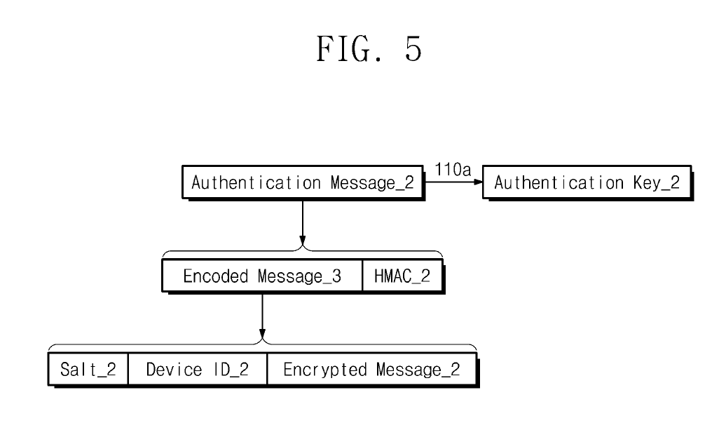

FIG. 5 is a block diagrams illustrating an example of method obtaining data from an authentication message.

The hub 130 may receive an authentication message “Authentication Message_2” from any source. The authentication message “Authentication Message_2” may include data that is similar to the authentication message “Authentication Message_1” of FIG. 4.

Accordingly, the authentication message “Authentication Message_2” may include an encoded message “Encoded Message_3” and a hash message authentication code “HMAC_2”. In addition, the encoded message “Encoded Message_3” may include an encrypted message “Encrypted Message_2”, a salt “Salt_2”, and a device ID “Device ID_2”.

Accordingly, the hub 130 may obtain the encoded message “Encoded Message_3”, the hash message authentication code “HMAC_2”, the salt “Salt_2”, the device ID “Device ID_2”, and the encrypted message “Encrypted Message_2” from the authentication message “Authentication Message_2”.

As described with reference to FIG. 1, the hub 130 may receive an identifier and a secret key from the key management system 110. The hub 130 may obtain an authentication key “Authentication Key_2” based on the received identifier and secret key and the obtained salt “Salt_2” and the obtained device ID “Device ID_2”. More specifically, the hub 130 may obtain the authentication key “Authentication Key_2” according to the protocol 110a of FIG. 3.

FIG. 6 is a block diagram illustrating an example of protocol 131a to verify an authentication message in a hub in reference to FIG. 1.

A decoding operation 131_1 and verify operations 131_3 to 131_5 of FIG. 6 to be described below may be performed in a processor included in the hub 130 of FIG. 1. The operations of FIG. 6 may be performed by a processor that operates in a secure mode based on the TEE 131. Accordingly, a process of FIG. 6 may be safely protected from an external attack.

In an example of FIG. 6, the decoding operation 131_1 may decode data encoded by the encoding operation 121_1 by using a symmetric key (e.g., an encoding key “Enc Key_2” of FIG. 6). The encoding key “Enc Key_1” of FIG. 4 may be the same as the encoding key “Enc Key_2”.

In an example of FIG. 6, the verify operations 131_3 to 131_5 may include an operation in which received data is compared with reference data. As described with reference to FIG. 3, the verify operations 131_3 to 131_5 may include XOR operation.

In an example of FIG. 6, a message authentication code operation 131_2 creates data in a manner that is similar to the message authentication code operation 121_2 of FIG. 4, and a description thereof is thus omitted.

As described with reference to FIG. 5, the hub 130 may obtain the encoded message “Encoded Message_3”, the hash message authentication code “HMAC_2”, and the encrypted message “Encrypted Message_2”.

The hub 130 may obtain the encoding key “Enc Key_2” and a message authentication key “Mac Key_2” from the authentication key “Authentication Key_2”. A relationship between the encoding key “Enc Key_2”, the message authentication key “Mac Key_2”, and the authentication key “Authentication Key_2” may be similar to the description given with reference to FIG. 4, and a description thereof is thus omitted.

The authentication key “Authentication Key_2” of FIG. 6 may correspond to the authentication key “Authentication Key_1” of FIG. 4. For example, the authentication key “Authentication Key_2” may be in a symmetric key relation with the authentication key “Authentication Key_1” of FIG. 4. The message authentication key “Mac Key_2” of FIG. 6 may correspond to the message authentication key “Mac Key_1” of FIG. 4. The encoding key “Enc Key_2” of FIG. 6 may correspond to the encoding key “Enc Key_1” of FIG. 4.

The hub 130 may perform the decoding operation 131_1 by using the encoding key “Enc Key_2”. The hub 130 may obtain a fourth data block “Data Block_4” from the encrypted message “Encrypted Message_2” by the decoding operation 131_1.

The hub 130 may perform the message authentication code operation 131_2 by using the encoding key “Enc Key_2”. The hub 130 may create a hash message authentication code “HMAC_3” from the encoded message “Encoded Message_3” by the message authentication code operation 131_2.

The fourth data block “Data Block_4” may include a verify ID “Verify ID_2” and a time stamp “Time Stamp_2”. Accordingly, the hub 130 may obtain the verify ID “Verify ID_2” and the time stamp “Time Stamp_2” from the fourth data block “Data Block_4”.

The hub 130 may authenticate the verify ID “Verify ID_2” by the verify operation 131_3. As described with reference to FIG. 4, before the end device 120 creates the authentication message “Authentication Message_1”, the hub 130 and the end device 120 may share the verify ID “Verify ID_1”. The hub 130 may compare the verify ID “Verify ID_2” obtained from the fourth data block “Data Block_4” and the verify ID “Verify ID_1”. The verify ID “Verify ID_1” may be used as reference data. For example, the hub 130 may determine whether the verify ID “Verify ID_1” and the verify ID “Verify ID_2” coincide with each other, by the XOR operation included in the verify operation 131_3. In a case where the verify ID “Verify ID_1” and the verify ID “Verify ID_2” coincide with each other, the hub 130 may create a first authentication value.

That the verify ID “Verify ID_1” and the verify ID “Verify ID_2” coincide with each other may mean that a source of the authentication message “Authentication Message_2” is the end device 120.

The hub 130 may verify the time stamp “Time Stamp_2” by the verify operation 131_4. As described with reference to FIG. 4, the time stamp “Time Stamp_1” may include data associated with a time when the encrypted message “Encrypted Message_1” is created. It may be understood in a similar context that the time stamp “Time Stamp_2” includes data associated with a time when the encrypted message “Encrypted Message_2” is created. Accordingly, the hub 130 may obtain data associated with a time, which is considered as a time when the encrypted message “Encrypted Message_2” is created, based on the time stamp “Time Stamp_2”. In addition, the hub 130 may obtain data associated with a time when the authentication message “Authentication Message_2” is received, from an embedded clock device.

On the basis of the obtained pieces of data, the hub 130 may compare the time when the encrypted message “Encrypted Message_2” is created with the time when the authentication message “Authentication Message_2” is received. If a difference between the time when the encrypted message “Encrypted Message_2” is created and the time when the authentication message “Authentication Message_2” is received is less than a reference time duration, the hub 130 may create a second authentication value.

That the difference between the time when the encrypted message “Encrypted Message_2” is created and the time when the authentication message “Authentication Message_2” is received is less than the reference time duration may mean that a source of the authentication message “Authentication Message_2” is the end device 120.

In addition, authentication using a time stamp may prevent a reply attack of an attacker. For example, the end device 120 may send an authentication message to the hub 130. The sent authentication message may be leaked out by an attacker. The attacker may send the leaked authentication message to the hub 130 once or more. Accordingly, the hub 130 may receive one or more similar authentication messages. The hub 130 may obtain data associated with times from time stamps included in the received authentication messages. The hub 130 may compare the data associated with the times, and determine an authentication message created at the earliest time. The hub 130 may create a second authentication value with respect to only an authentication message determined as being created at the earliest time.

That an authentication message is determined as being created at the earliest time may mean that a source of the authentication message is the end device 120.

The hub 130 may verify the hash message authentication code “HMAC_3” by the verify operation 131_5. As described with reference to FIG. 5, the hub 130 may obtain the hash message authentication code “HMAC_2”. The hub 130 may compare the hash message authentication code “HMAC_2” with the hash message authentication code “HMAC_3”. A method of comparing the hash message authentication code “HMAC_2” with the hash message authentication code “HMAC_3” may be similar to a method of comparing the verify ID “Verify ID_1” with the “Verify ID_2”. In a case where the hash message authentication code “HMAC_2” and the hash message authentication code “HMAC_3” coincide with each other, the hub 130 may create a third authentication value.

That the hash message authentication code “HMAC_2” and the hash message authentication code “HMAC_3” coincide with each other may mean that the authentication message “Authentication Message_2” is not tampered with in a transmission process.

In a case where the first to third authentication values are all created, the hub 130 may create a fourth authentication value indicating that the authentication message “Authentication Message_2” is verified.

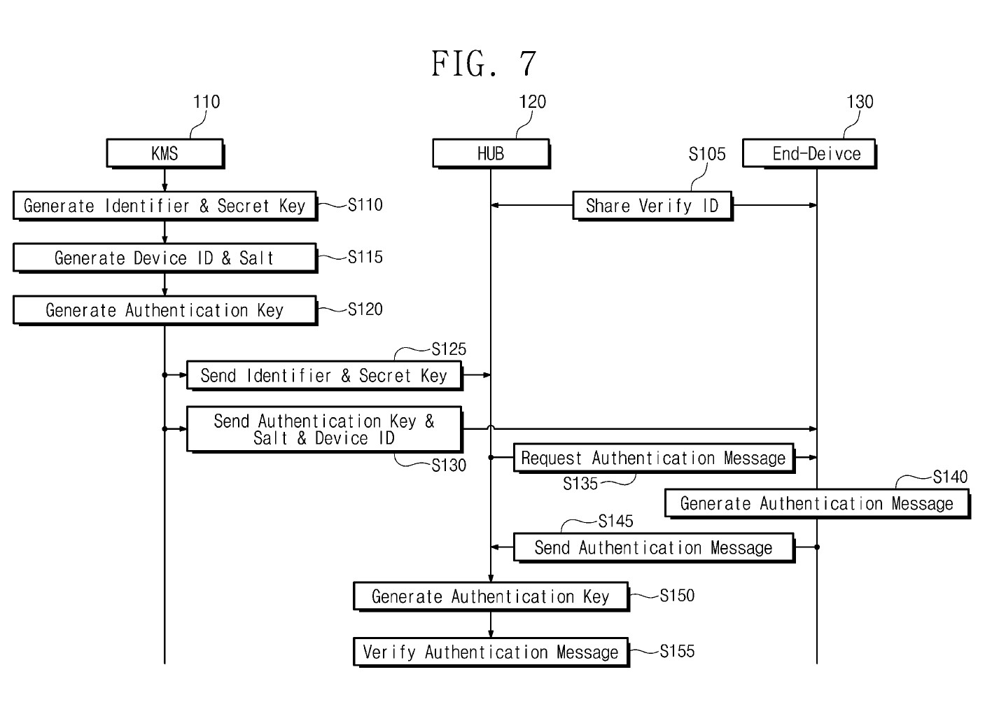

FIG. 7 is a flowchart illustrating an example of method for verifying an authentication message by an authentication system in reference to FIGS. 1, 3 and 4 according to an exemplary embodiment of the inventive concept.

In operation S105, the end device 120 and the hub 130 may share a verify ID. In the case of operation S105, the reference numeral S105 may not be associated with an order of operations. Operation S105 may be performed before operation S140 is performed.

In operation S110, as described with reference to FIG. 1, the key management system 110 may create an identifier and a secret key.

In operation S115, the key management system 110 may create a device ID and a salt. As described with reference to FIG. 1, the salt may be used to allow different hash values to be calculated from the same data and the same hash function. The device ID may include data associated with the end device 120.

In operation S120, the key management system 110 may generate an authentication key according to the protocol 110a described with reference to FIG. 3.

In operation S125, the key management system 110 may send the identifier and the secret key created in operation S110 to the hub 130. For example, the identifier and the secret key may be sent at a point in time when the hub 130 is manufactured. The sent identifier and secret key may be stored in the hub 130. The sent identifier and secret key may be stored in a processor that provides a security function based on the TEE 131 (refer to FIG. 8).

In operation S130, the key management system 110 may send the authentication key, the salt, and the device ID created in operation S115 and operation S120 to the end device 120. For example, the authentication key, the salt, and the device ID may be sent at a point in time when the end device 120 is manufactured. The authentication key, salt, and device ID received from the key management system 110 may be stored in the end device 120. The authentication key received from the key management system 110 may be stored in a secure module that provides a security function based on the SE 121 (refer to FIG. 8).

In operation S135, as described with reference to FIG. 1, when there is a need for authentication of the end device 120, the hub 130 may make a request to the end device 120 for authentication. For example, the hub 130 may send an authentication request message for requesting authentication to the end device 120.

In operation S140, the end device 120 may create an authentication message in response to a request of the hub 130. The end device 120 may create the authentication message according to the protocol 120a described with reference to FIG. 4. Operation S140 may be performed in a secure module that provides a security function based on the SE 121. (FIG. 8)

In operation S145, the end device 120 may send the authentication message created in operation S140 to the hub 130. The end device 120 may send the authentication message through a secure channel or a normal channel.

In operation S150, the hub 130 may create an authentication key based on the authentication message received in operation S145, and an identifier and a secret key received in operation S125. The hub 130 may obtain the authentication key according to the protocol 110a described with reference to FIG. 3. Operation S150 may be performed in a processor that provides a security function based on the TEE 131. (FIG. 8)

In operation S155, the hub 130 may verify the authentication message received in operation S145, according to the protocol 131a of FIG. 6. The hub 130 may respectively verify the obtained verify ID, time stamp, and hash message authentication code based on the authentication key created in operation S150. The hub 130 may make use of the verify ID shared in operation S105 upon verifying the verify ID. Operation S155 may be performed in a processor that provides a security function based on the TEE 131. (FIG. 8)

FIG. 8 is a block diagram illustrating an example of electronic device implementing an end device and a hub in reference to FIG. 1.

Referring to FIG. 8, an electronic device 200 may include a processor 210, a memory 220, storage 230, a secure module 240, a communication device 250, a user interface 260, and a bus 270. The electronic device 200 may further include other elements (e.g., a sensor and a power supply) that are not illustrated in FIG. 8. Alternatively, the electronic device 200 may not include one or more of elements that are illustrated in FIG. 8.

The processor 210 may control overall operations of the electronic device 200. For example, the processor 210 may execute an application and the like for convenience of a user. For example, the hub 130 of FIG. 1 may include the processor 210. The processor 210 may operate in a secure mode based on the TEE 131. The processor 210 may obtain an authentication key according to the protocol 110a of FIG. 3 in the secure mode based on the TEE 131. The processor 210 may verify an authentication message according to the protocol 131a of FIG. 6 in the secure mode based on the TEE 131. Accordingly, the hub 130 may prevent a process from being leaked out by an attacker.

For example, the processor 210 may be one of a general-purpose processor, a workstation processor, an application processor, etc. The processor 210 may include a single core or may include a multi-core. For example, the processor 210 may include a multi-core such as a dual-core, a quad-core, or a hexa-core.

In addition, the processor 210 may further include a memory 211 that is placed inside or outside the processor 210. The memory 211 may be a storage device that provides the security function based on TEE. The memory 211 may store data, which needs a high level of security, at a location to provide the secure mode based on the TEE 131. For example, the memory 211 may store data or like illustrated in FIGS. 3 5, and 6 at a location to provide the secure mode based on the TEE 131.

The memory 220 may store data processed or to be processed by the processor 210. The data processed or to be processed by the processor 210 may include data, which needs a relatively low level of security, of data associated with the authentication system according to an exemplary embodiment of the inventive concept. For example, the memory 220 may store data associated with a third data block, an encoded message, an authentication message, etc. of FIG. 4.

For example, the memory 220 may include a volatile memory such as a static random access memory (SRAM), a dynamic RAM (DRAM), or a synchronous DRAM (SDRAM), or a nonvolatile memory such as a flash memory, a phase-change RAM (PRAM), a magneto-resistive RAM (MRAM), a resistive RAM (ReRAM), or a ferro-electric RAM (FRAM). Alternatively, the memory 220 may include heterogeneous memories.

The storage 230 may store data regardless of power supply. For example, the storage 230 may store data, which needs a relatively low level of security, of data associated with the authentication system according to an exemplary embodiment of the inventive concept. For example, the storage 230 may store data associated with a third data block, an encoded message, an authentication message, etc. of FIG. 4.

For example, the storage 230 may be a storage medium, which includes a nonvolatile memory, such as a hard disk drive (HDD), a solid state drive (SSD), a secure digital (SD) card, or a universal serial bus (USB) memory device.

The secure module 240 may process or store data that requires a high level of security. For example, the end device 120 of FIG. 1 may include the secure module 240. The secure module 240 may operate in an secure mode based on the SE 121. The secure module 240 may perform operations of FIG. 4 in the secure mode based on SE. Accordingly, the end device 120 may prevent a process from being leaked out by an attacker.

The communication device 250 may include a transmitter and a receiver. The electronic device 200 may communicate with another electronic device through the communication device 250 to transmit and/or receive data. For example, the electronic device 200 may exchange data with at least one of a key management system, end devices, and hubs through the communication device 250. For example, data exchanged through the communication device 250 may include data associated with at least one of an authentication message and an authentication key.

The user interface 260 may convey an input/output of a command or data between the user and the electronic device 200. For example, the user interface 260 may include a physical device such as an input device and/or an output device. The input device may include a keyboard, a mouse, a touchscreen, a scanner, a joystick, a voice recognition device, a motion recognition device, or an eyeball recognition device, and the output device may include a monitor, a display device, a projector, a speaker, or a plotter.

The bus 270 may provide a communication path between the elements of the electronic device 200. For example, the processor 210, the memory 220, the storage 230, the secure module 240, the communication device 250, and the user interface 260 may exchange data with each other through the bus 270. The bus 270 may be configured to support various types of communication formats used in the electronic device 200.

The electronic device 200 of FIG. 8 may operate as a computing device. For example, the key management system 110 of FIG. 1 may include one or more electronic devices 200. The key management system 110 may generate a plurality of authentication keys by one or more electronic devices 200.

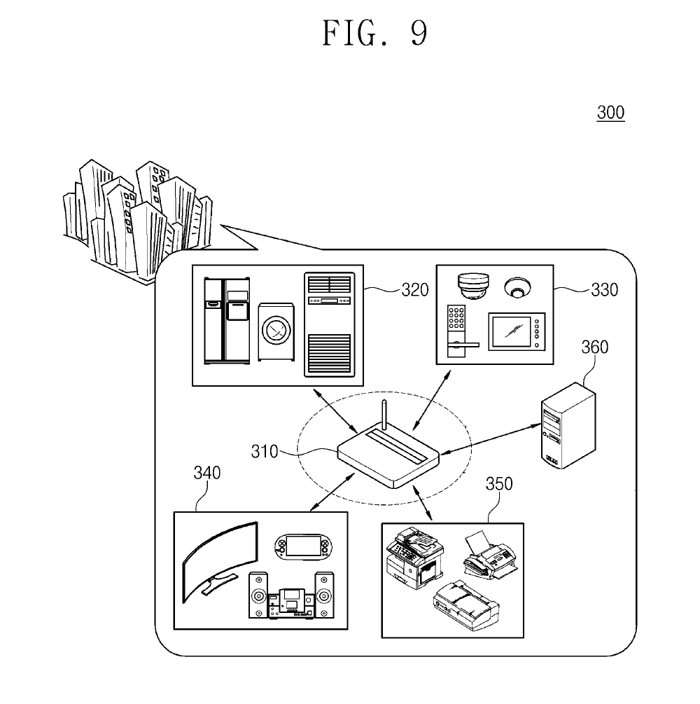

FIG. 9 is a conceptual diagram illustrating an example of IoT system for implementing an authentication system, according to an exemplary embodiment of the inventive concept.

The IoT system according to an exemplary embodiment of the inventive concept may be implemented with at least one of a home network system, a military network system, a company network system, and the like. The IoT system according to an exemplary embodiment of the inventive concept may be an ad-hoc network or an infrastructure network. A home network system 300 will be described as an exemplification of the IoT system with reference to FIG. 9.

Referring to FIG. 9, the home network system 300 may include a hub 310 and a plurality of end devices 320 to 360. For example, the home network system 300 may include at least one of end devices such as a home appliance 320, such as a refrigerator, a washing machine, or an air conditioner, a security/safety device 330, such as a door lock, a closed-circuit television (CCTV), an intercom, a window sensor, a fire sensor, or an electrical plug, an entertainment device 340, such as a television, an audio, a game console, or a computer, an office machine 350, such as a printer, a projector, or a photocopier, and any other type of computing device 360. In addition, the home network system 300 may include various electronic devices or a sensing device.

The hub 310 of FIG. 9 may include the hub 130 of FIG. 1 and the processor 210 of FIG. 8. The plurality of end devices 320 to 360 of FIG. 9 may include the end device 120 of FIG. 1 or the end devices 120_1 to 120_n of FIG. 2, respectively, and the secure module 240 of FIG. 8.

The home network system 300 may control various end devices in a building (e.g., a house, an apartment, or a building) through a wired/wireless network. The end devices may transmit and/or receive data via the hub 310.

The home network system 300 may include various wired/wireless communication networks. For example, the home network system 300 may include a sensor network, an M2M network, an Internet protocol (IP)-based network, a non-IP-based network, and the like. More specifically, the home network system 300 may include at least one of wired communication network, such as Home PNA (Home Phone line Networking Alliance), IEEE1394, USB (Universal Serial Bus), PLC (Power Line communication), or Ethernet, a wireless communication network, such as IrDA (Infrared Data Association), Bluetooth, Wi-Fi (Wireless Fidelity), WLAN (Wireless LAN), UWB (Ultra Wide Band), ZigBee, Wireless 1394, Wireless USB, NFC (Near Field Communication), or RFID (Radio-frequency identification), and a mobile communication network, such as 3G (3rd Generation), 4G (4th Generation), or LTE (Long Term Evolution).

For example, the home network system 300 may transmit and/or receive data associated with an authentication system according to an exemplary embodiment of the inventive concept through the wired/wireless communication network. For example, the hub 310 may send authentication request messages to the end devices 320 to 360 through the wired/wireless communication network. The end devices 320 to 360 may send authentication messages through the wired/wireless communication network. The hub 310 may receive authentication messages from the end devices 320 to 360 through the wired/wireless communication network. The wired/wireless communication network may include at least one of a secure channel and a normal channel.

The end devices 320 to 360 may be verified through the verification method described with reference to FIG. 7. The hub 310 may exchange data with an end device, which is verified, from among the plurality of end devices 320 to 360. Accordingly, the data that the hub 310 and the end devices 320 to 360 exchange may be safely protected from an external attack.

According to an exemplary embodiment of the inventive concept, an authentication system for performing secure authentication may be provided.

While the inventive concept has been described with reference to exemplary embodiments, it will be apparent to those skilled in the art that various changes and modifications may be made without departing from the spirit and scope of the inventive concept. Therefore, it should be understood that the above exemplary embodiments are not limiting, but illustrative.

What is claimed is:

1. An electronic device comprising:
a processor configured to:
obtain a first authentication key based on first data and a first authentication message, verify the first authentication message based on the first authentication key, obtain a second authentication key based on second data and a second authentication message, and verify the second authentication message based on the second authentication key; and
a memory configured to store the first data, the first authentication message, the first authentication key, the second data, the second authentication message, and the second authentication key,
wherein the second authentication message is different from the first authentication message, the second authentication key is different from the first authentication key, the first authentication key is associated with a first end device, and the second authentication key is associated with a second end device.

2. The electronic device of claim 1, wherein the processor is configured to verify the first authentication message based on a message authentication code included in the first authentication message and at least one of a verify identifier shared with the first end device and a time when the first authentication message is received at the electronic device.

3. The electronic device of claim 1, wherein the processor is configured to verify the first authentication message in response to a message authentication code included in the first authentication message coinciding with a message authentication code obtained from an encoded message included in the first authentication message, a verify identifier shared with the first end device coinciding with a verify identifier obtained from the encoded message, and a difference between a time when the first authentication message is received at the electronic device and a time when the encoded message is created at the first end device is less than a reference time duration.

4. The electronic device of claim 3, wherein the first authentication key comprises an encoding key and a message authentication key, and
wherein the encoding key is used to obtain, from an encrypted message included in the encoded message, the verify identifier and information about the time when the encoded message is created, and
wherein the message authentication key is used to obtain the message authentication code from the encoded message.

5. The electronic device of claim 1, wherein the first data comprises data associated with an identifier and data associated with a secret key, and
wherein the first authentication message comprises a hash message authentication code and an encoded message, the encoded message comprises an encrypted message, and the encrypted message comprises data associated with a verify identifier and data associated with a time when the encrypted message is created at the first end device.

6. The electronic device of claim 5, wherein the first authentication key comprises an encoding key and a message authentication key, and
wherein the processor is configured to obtain the data associated with the time and the data associated with the verify identifier based on the encoding key and the encrypted message, and obtain the hash message authentication code by using the message authentication key and the encoded message.

7. The electronic device of claim 5, wherein the processor is configured to verify the data associated with the time, the data associated with the verify identifier, and the hash message authentication code.

8. An electronic device comprising:
a secure module configured to create a first authentication message based on a first authentication key; and
a memory configured to store data associated with the first authentication message,
wherein the first authentication key is associated with the secure module,
wherein the first authentication key is different from a second authentication key associated with another secure module, and
wherein the first authentication message is different from a second authentication message associated with the second authentication key.

9. The electronic device of claim 8, wherein the first authentication key comprises:
an encoding key configured to encode the at least one of a verify identifier and a time stamp; and
a message authentication key configured to create a message authentication code.

10. The electronic device of claim 8, wherein the secure module creates the first authentication key and an encrypted message associated with a time and a verify identifier in a secure mode, and
wherein the secure module creates a hash message authentication code based on the first authentication key and the encrypted message in the secure mode, and
wherein the encrypted message is encoded based on the first authentication key.

11. The electronic device of claim 10, wherein the time comprises data associated with a time when the encrypted message is created.

12. An electronic device comprising:
a processor configured to:
receive a first authentication message created from a first authentication key associated with a first end device, receive a second authentication message created from a second authentication key associated with a second end device,
obtain a third authentication key from the first authentication message, obtain a fourth authentication key from the second authentication message,
verify the first authentication message based on the third authentication key, and
verify the second authentication message based on the fourth authentication key; and
a memory configured to store data associated with the first authentication message, the second authentication message, the third authentication key, and the fourth authentication key,
wherein the third authentication key is a symmetric key with respect to the first authentication key, and the fourth authentication key is a symmetric key with respect to the second authentication key.

13. The electronic device of claim 12, wherein the processor obtains an identifier of the first end device and a salt, which is used to perform a hash function to generate the first authentication key, from the first authentication message, receives an identifier and a secret key from a key management system, and obtains the third authentication key using the obtained identifier of the first end device, the obtained salt, the received identifier, and the received secret key.

14. The electronic device of claim 12, wherein the processor verifies the first authentication message and the second authentication message in a secure mode.

15. The electronic device of claim 14, wherein the first authentication message is received from the first end device through at least one of a normal channel and a secure channel.

16. The electronic device of claim 12, wherein the processor and the memory are included in a hub constituting an Internet of Things system, and
wherein a plurality of end devices, comprising the first end device and the second end device, constituting the Internet of Things system exchange data with one another through the hub.

17. The electronic device of claim 12, wherein the first authentication key is created by a key management system, and is sent to the first end device, and
wherein the first authentication key is created based on a salt used to perform a hash function, an identifier of the first end device, and a secret key.

18. The electronic device of claim 12, further comprising a communication device configured to receive an identifier and a secret key from a key management system and to receive the first authentication message,
wherein the processor receives the first authentication key created based on an encoded message and the secret key, and the encoded message is associated with the identifier, a salt, and a device identifier,
wherein the identifier and the device identifier include data associated with the first end device.
